(19) United States
(12) Patent Application Publication
(10) Pub. No.: US 2007/0062051 A1
(43) Pub. Date: Mar. 22, 2007

(54) Surface marking apparatus

(76) Inventor: Luke Harry George Ingram, Worcester (GB)

Correspondence Address: DAVID A. GUERRA;INTERNATION PATENT GROUP, LLC, 2025 17TH AVENUE N.W., CALGARY, AB, T2M 0S7, CA

(21) Appl. No.: 10/558,581

(22) PCT Filed: Jun. 3, 2004
(86) PCT No.: PCT/GB04/02368

§ 371 Date: Nov. 30, 2005

(30) Foreign Application Priority Data
Jun. 5, 2003 (GB) 0312908.7

(51) Int. Cl. B43L 13/02

(52) U.S. Cl. 33/42

(57) ABSTRACT

A surface marking apparatus comprises a body member (3) having a first face (9) for engaging a surface of an object to be marked and a second face (17), arranged substantially at right angles to the first face (9), for engaging an edge of the object to be marked. Surface marking means (11) is provided, the marking means (11) being slidably mounted relative to the first face (9) of the body member (3). Means for securing the marking means (11) in a selected position relative to the first face (9) of the body member (3) is also provided.

This invention relates to a surface marking apparatus.

It is known by a person skilled in the art that a marking gauge can be used to produce a straight line on an object, for example a piece of wood or metal. A marking gauge marks a line on the surface of the object at a required distance from an edge of the object.

One form of a marking gauge known to a person skilled in the art comprises an elongate body with a sharpened spike through one end of the body. A stop is slidably movable along the elongate body. The stop can be fixed, for example by means of a screw, at a distance relative to the spike which corresponds to the distance between the edge of the object and the required position for a marked line. By maintaining contact between the stop and the edge of an object the spike can be drawn across the surface of the object producing a mark on the surface of the object.

A problem with this form of a marking gauge is that it is relatively difficult to accurately set the distance between the spike and the stop.

An alternative means of marking the surface of an object is to use a pair of “odd leg” calipers, known to a person skilled in the art. The end of one leg of the caliper is used to contact an edge of an object and the end of the other leg of the caliper comprises a spike for marking a surface. “Odd leg” calipers enable the distance between the ends of the legs to be more accurately set than with the marking gauge described above. However there is no locking device to fix the distance and so in use the distance between the ends of the legs can be accidentally altered leading to inaccurate marking of a surface.

There is a need, therefore, for a surface marking apparatus which can be relatively easily set to mark a line in a required position on an object relative to an edge of the said object.

It is therefore an object of the present invention to provide a surface marking apparatus which overcomes or minimises these problems.

According to the present invention there is provided a surface marking apparatus comprising: a body member having a first face for engaging a surface of an object to be marked and a second face, arranged substantially at right angles to the first face, for engaging an edge of the object to be marked; surface marking means, the marking means being slidably mounted relative to the first face of the body member; and means for securing the marking means in a selected position relative to the first face of the body member.

The marking means may be in the form of a marking spike or a marking wheel, for example of hardened steel, mild steel or brass.

The marking means may be slidably mounted within an elongate aperture provided in the body member. The elongate aperture may have a longitudinal direction extending substantially perpendicular to the second face of the body member.

The body member may comprise a plastics material.

The securing means may comprise a bolt, for example of mild steel. The securing means may pass through an aperture in the body member of the apparatus and be threaded to the marking means such that rotation of the securing means relative to the marking means secures the marking means in position relative to the body member.

First calibration means may be provided on the body member to enable the distance between the marking means and the second face of the body member to be set accurately.

Holding means suitable to improve the grip of a user on the apparatus, for example recesses in the body member and/or a handle extending from the body member, may be provided.

The body member may include a plate member on which the second face is provided. The plate member may be slidable relative to the remainder of the body member. The plate member may be movable relative to the remainder of the body member by extension means such that the plate member is slidably movable, in a direction longitudinal to the body member, relative to an end of the body member furthest from the plate member.

The extension means may comprise screw-threaded adjustment means.

Positioning means, for example at least one locator pin, may be provided between the body means and the plate means to retain the second face on the plate member parallel to the end of the body member furthest from the plate member.

Second calibration means may be provided on the positioning means to enable the distance between the second face on the plate member and the marking means to be set accurately.

Means may be provided for indicating the position of the marking means relative to the second face of the body member.

For a better understanding of the present invention and to show more clearly how it may be carried into effect reference will now be made, by way of example, to the accompanying drawings in which:

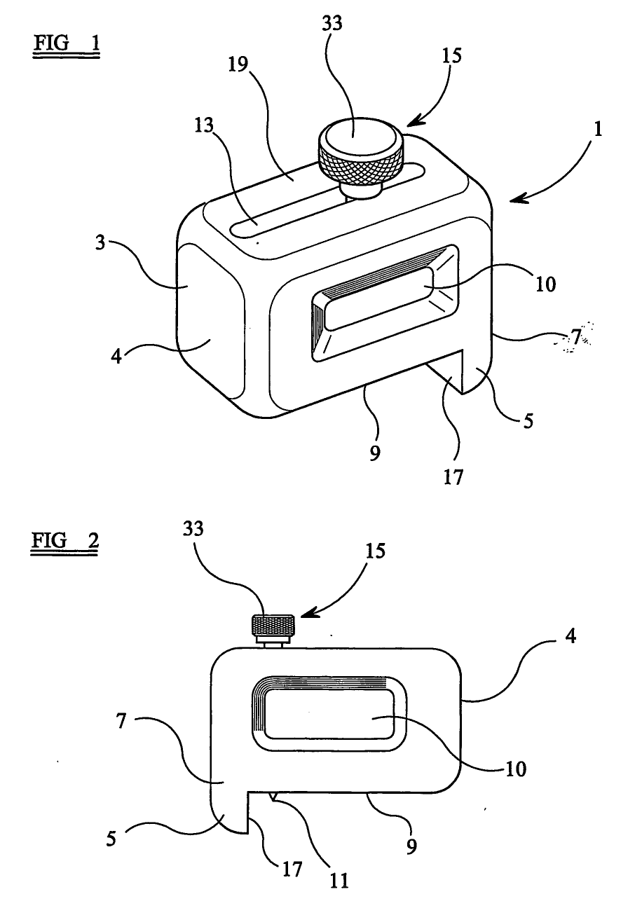

FIG. 1 is a perspective view of an embodiment of a surface marking apparatus according to the present invention;

FIG. 2 is a side view of the surface marking apparatus shown in FIG. 1;

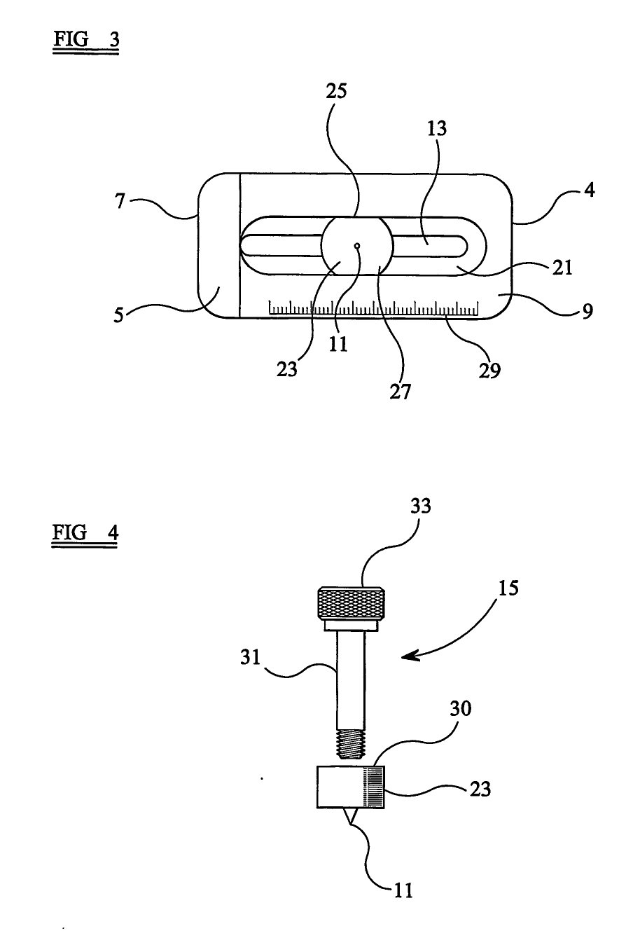

FIG. 3 is a bottom view of the surface marking apparatus shown in FIGS. 1 and 2;

FIG. 4 is a side view of marking means and securing means incorporated in a surface marking apparatus according to the present invention;

FIG. 5 is a side view of another embodiment of a surface marking apparatus according to the present invention;

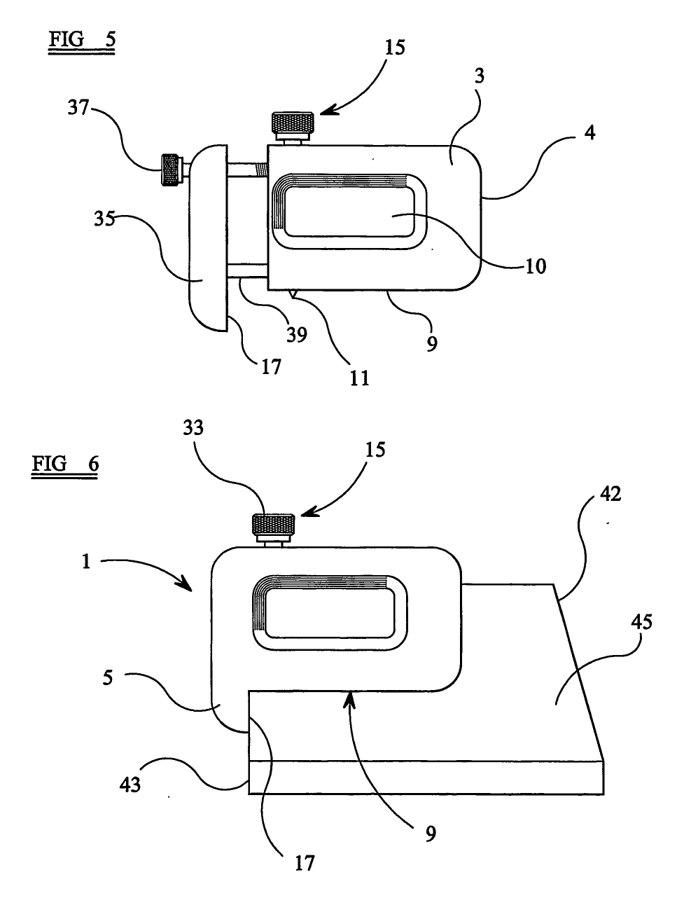

FIG. 6 is a perspective view of the surface marking apparatus in FIGS. 1 to 3 shown in relation to an object to be marked;

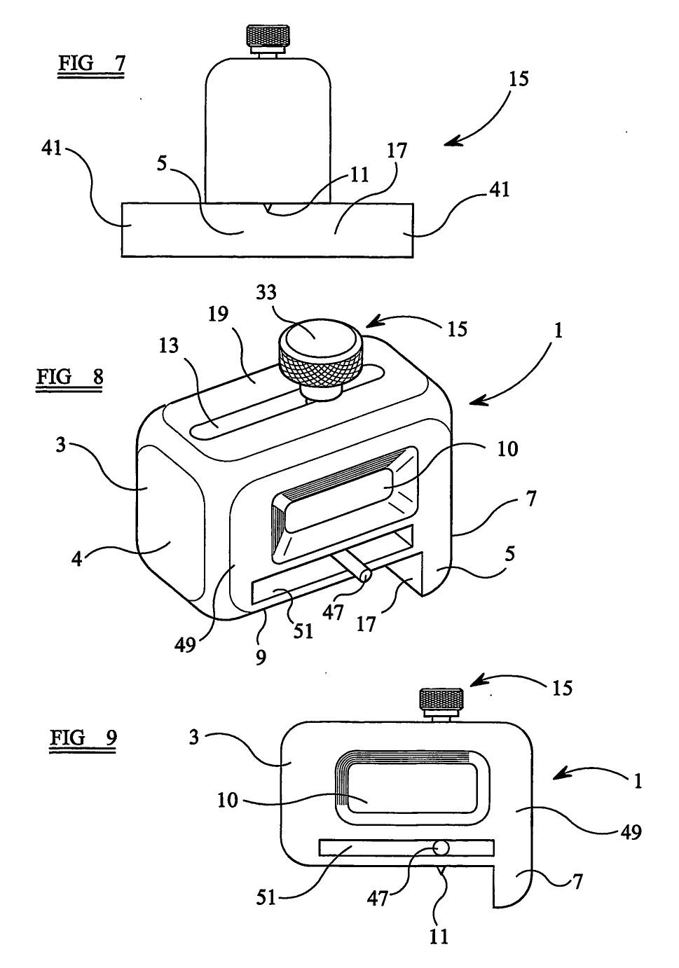

FIG. 7 is a front view of a further embodiment of a surface marking apparatus according to the present invention;

FIG. 8 is a perspective view of a yet further embodiment of a surface marking apparatus according to the present invention; and

FIG. 9 is a side view of the surface marking apparatus shown in FIG. 8.

FIGS. 1, 2 and 3 show a surface marking apparatus according to the present invention. The apparatus 1 comprises a substantially cuboid body 3, preferably of a plastics material. The body has a longitudinal direction extending between an end 4 and an end 7 of the body. A protruding member 5 extends downwards, in use, from the end 7 of a first face 9 of the body 3. The first face 9 of the body is lowermost in use.

Provided in the two opposing sides of the body of the apparatus, which may be held in use, is a shallow recess 10 to enable the body to be gripped securely.

It can be seen from FIGS. 1 and 2 that a second face 17 of the body, provided innermost on the protruding member 5, that is furthest from the end 7 of the body, forms substantially a right angle with the first face 9 of the body.

A marking spike 11, for example of hardened steel, mild steel or brass, suitable for marking a surface, for example of wood or metal, protrudes from an elongate aperture 13 in the first face 9 of the body 3. Means 15 for securing the position of the marking spike 11 relative to the longitudinal direction of the aperture in the body 3 is provided in an opening of the elongate aperture 13 in a third face 19, uppermost in use, of the body 3.

The elongate aperture 13 extends in the longitudinal direction of the body 3 substantially perpendicular to the inner second face 17 and passes through the body 3 between the third face 19 and the first face 9 of the body. A recess is formed in the first face around the opening of the aperture such that a shoulder 21 is formed around the opening of the aperture.

The marking spike 11 is slidably mounted in the elongate aperture in the first face 9. As shown in FIG. 4, the marking spike is mounted on a substantially cylindrical base 23 which is dimensioned to fit within the opening of the aperture 13 in the first face 9 of the body such that only a proportion of the mounting spike extends beyond the first face 9. Opposite sides 25, 27 of the base are substantially flattened such that rotation of the base within the aperture is prevented. The base of the marking spike can be slidably moved along the aperture in the longitudinal direction of the body. An upper surface 30 of the base 23 is positioned against the shoulder 21 of the aperture such that movement of the base towards the third face 19 of the body is restricted.

Calibration means in the form of a measuring scale 29, for example showing 1 mm divisions, is provided on the first face 9 adjacent to the aperture. In this way the distance between the point of the mounting spike 11 and the inner second face 17 of the protruding member can be accurately set, for example to the nearest 0.5 mm. The distance set is equivalent to a required distance at which a line is to be produced by the marking spike from an edge of an object to be marked.

Securing means, for example in the form of a mild steel bolt, is attached to the upper surface 30 of the base of the marking spike. The securing means is used to releasably secure the position of the marking spike relative to the longitudinal direction of the elongate aperture. The securing means comprises a head 33 in the form of a knob, and an elongate body 31 which passes through the aperture and is threaded onto the base 23 of the marking spike. The head 33 of the securing means is wider than the aperture and protrudes from the third face 19 of the body. The arrangement of the securing means and the marking spike is shown in FIG. 4.

The dimension of the aperture in the longitudinal direction of the body provides a finite distance that can be set between the marking spike and the inner face 17 of the protruding member 5.

As shown in FIG. 5, another embodiment of a surface marking apparatus in accordance with the present invention comprises the protruding member 5 provided on a plate 35 that is movable relative to the body 3.

If a distance is required additional to that possible by movement of the marking spike within the elongate aperture, relative to a fixed position of the protruding member, the plate 35 on which the protruding member is provided can be slidably moved relative to the longitudinal direction of the body. As such the distance between the marking spike and the inner f ace 17 of the protruding member can be increased, as shown in FIG. 5.

The plate 35 is moved relative to the body by rotating a screw-threaded adjustment means 37. The screw-threaded adjustment means, for example an elongate bolt, passes through the plate 35 and is threaded into a screw-threaded bore provided in the body.

Guide means 39, for example in the form of a locator pin, ensures that the inner face 17 of the protruding member remains substantially at right angles to the first face 9 of the body. The guide means is rigidly attached to the plate and slidably moves within a guide track (not shown) provided within the body.

Calibration means in the form of a measurement scale (not shown) is provided on the locator pin to facilitate the accurate setting of the distance between the marking spike and the inner face 17 of the protruding member.

In use, the marking spike is moved along the aperture 13 to the required distance from the inner face 17 of the protruding member. This distance can be set by reference to the measurement scale provided adjacent to the aperture.

When the marking spike is correctly positioned, the head 33 of the securing means 15 is rotated to reduce the distance between the head of the securing means and the upper surface 30 of the base 23 of the marking spike. The base is prevented from moving upwards through the aperture by the shoulder 21 provided in the recess around the aperture in the first face 9 of the body. The head of the securing means is too large to enter the opening of the aperture. Continued rotation of the head of the securing means tightens the upper surface of the base of the marking spike against the shoulder of the aperture and prevents further movement of the marking spike.

As shown in FIG. 6, to mark a surface of an object 42 the apparatus 1 is positioned and held such that the inner face 17 of the protruding member is in contact with one face 43 of the object 42 and the marking spike 11 is in contact with a second face 45 of the object. By maintaining contact between the first face 43 of the object to be marked and the inner face 17 of the protruding member, linear movement of the apparatus along the first face 43 of the object causes the marking spike to mark a line in the second face 45 of the object, parallel to the first side 43 of the object.

Although a surface marking apparatus in accordance with the present invention has been described hereinbefore as having a recess to provide a grippable surface on the body it should be appreciated that the body could be provided with other means of improving a user's grip, for example moulded undulations in the surface of the body. A handle could also be provided, preferably rigidly attached to the body.

Although a marking spike has been described as the means of marking a surface it should be appreciated that other means of marking a surface, for example a marking wheel, could also be used in a surface marking apparatus in accordance with the present invention.

To provide additional contact between the inner face 17 of the protruding member and an object to be marked, the inner face 17 could be provided with wing-like members 41 that extend on either side of the protruding member such that the face 17 transverse to the longitudinal direction of the body is greater than the width of the body, as shown in FIG. 7.

FIGS. 8 and 9 show an embodiment in accordance with the present invention in which an indicator means 47 is provided extending from a side 49 of the body 3, The indicator means 47 indicates the position of the portion of the marking spike 11 which will, in use, be in contact with a face of an object to be marked such that a user viewing the surface marking apparatus from above can determine the position of the marking spike relative to the second face 17 of the body.

The indicator means 47 comprises an elongate rod which is fixed to a portion (not shown) of the base of the marking spike. The portion of the base extends away from the opening of the aperture 13 in the first face, beyond the shoulder 21 of the aperture, towards the securing means 15, these features being substantially as described hereinbefore.

The elongate rod is provided substantially perpendicular to the axis of the marking spike and arranged to protrude from an elongate aperture 51, in the side 49 of the body 3, the aperture 51 being substantially parallel to the longitudinal axis of the body 3.

It should be appreciated that indicator means could be provided extending from opposing sides of the body 3. It should also be appreciated that indicator means can be provided to indicate the position of other means of marking a surface, for example a marking wheel.

It should be appreciated that means to attach a further, fixed spike resilient to wear, for example of hardened steel, mild steel or brass, to the first face 9 of the body may also be provided such that a surface marking apparatus in accordance with the present invention can be used as a mortice gauge in a manner well known to a person skilled in the art.

1-22. (canceled)

23: A surface marking apparatus for marking a surface of an object, said surface marking apparatus comprising:
a body member having a first face and a second face, said first face engagable to a surface of an object to be marked, said second face arranged substantially at right angles to said first face for engaging an edge of the object to be marked;
a surface marking means slidably mounted relative to said first face of said body member; and
a securing means for securing said marking means in a selected position relative to said first face of said body member.

24: The surface marking apparatus as set forth in claim 23, wherein said marking means is selected from the group consisting of a marking spike and a marking wheel.

25: The surface marking apparatus as set forth in claim 23, wherein said marking means is slidably mountable within an elongate aperture provided in said body member.

26: The surface marking apparatus as set forth in claim 25, wherein said elongate aperture has a longitudinal direction extending substantially perpendicular to said second face of said body member.

27: The surface marking apparatus as set forth in claim 23, wherein said securing means further comprising a bolt.

28: The surface marking apparatus as set forth in claim 23, wherein said securing means passes through an aperture in said body member and is threaded to said marking means such that rotation of said securing means relative to said marking means secures said marking means in position relative to said body member.

29: The surface marking apparatus as set forth in claim 23 further comprising a first calibration means on said body member to enable the distance between said marking means and said second face of said body member to be indicated.

30: The surface marking apparatus as set forth in claim 23 further comprising a holding means selected from the group consisting of recesses in said body member, and a handle extending from said body member.

31: The surface marking apparatus as set forth in claim 23 further comprising a plate member movably mounted to said body member, said plate member providing said second face.

32: The surface marking apparatus as set forth in claim 31, wherein said plate member is movable relative to said body member by extension means such that said plate member is slidably movable in a direction longitudinal to said body member, relative to an end of said body member furthest from said plate member.

33: The surface marking apparatus as set forth in claim 32 further comprising a positioning means provided between said body member and said plate member to retain said second face on said plate member parallel to the end of said body member furthest from said plate member.

34: The surface marking apparatus as set forth in claim 33 further comprising a second calibration means provided on said positioning means to enable the distance between said second face on said plate member and said marking means to be indicated.

35: The surface marking apparatus as set forth in claim 23 further comprising an indicating means provided for indicating the position of said marking means relative to said second face of said body member.

36: A surface marking apparatus comprising:
a body member having a first face, said first face engagable to a surface of an object to be marked;
a marking means slidably mounted within an elongate aperture provided in said body member;
a securing means for securing said marking means in a selected position relative to said first face of said body member;
a plate member slidably mountable to said body member, said plate member having a second face arranged substantially at right angles to said first face of said body member for engaging an edge of the object to be marked; and
a positioning means provided between said body member and said plate member to retain said second face on said plate member parallel to an end of said body member furthest from said plate member.

37: The surface marking apparatus as set forth in claim 36, wherein said elongate aperture has a longitudinal direction extending substantially perpendicular to said second face of said body member.

38: The surface marking apparatus as set forth in claim 36, wherein said securing means passing through said aperture in said body member is threaded to said marking means such that rotation of said securing means relative to said marking means secures said marking means in position relative to said body member.

39: The surface marking apparatus as set forth in claim 36, wherein said plate member is movable relative to said body member by extension means such that said plate member is slidably movable in a direction longitudinal to said body member, relative to the end of said body member furthest from said plate member.

40: The surface marking apparatus as set forth in claim 39, wherein said extension means comprises screw-threaded adjustment means.

41: The surface marking apparatus as set forth in claim 36 further comprising a first calibration means on said body member to enable the distance between said marking means and said second face to be indicated, and a second calibration means provided on said positioning means to enable the distance between said second face on said plate member and said marking means to be indicated.

42: A surface marking apparatus comprising:
a body member having a first face, said first face engagable to a surface of an object to be marked;
a marking means slidably mounted within an elongate aperture provided in said body member;
a securing means for securing said marking means in a selected position relative to said first face of said body member, said securing means passing through said aperture in said body member is threaded to said marking means such that rotation of said securing means relative to said marking means secures said marking means in position relative to said body member;
a plate member slidably mountable to said body member, said plate member having a second face arranged substantially at right angles to said first face of said body member for engaging an edge of the object to be marked;
a positioning means provided between said body member and said plate member to retain said second face on said plate member parallel to an end of said body member furthest from said plate member;
wherein said elongate aperture has a longitudinal direction extending substantially perpendicular to said second face of said body member; and
wherein said plate member is movable relative to said body member by extension means such that said plate member is slidably movable in a direction longitudinal to said body member relative to the end of said body member furthest from said plate member.
